(19) United States
(12) Patent Application Publication
(10) Pub. No.: US 2025/0110799 A1
(43) Pub. Date: Apr. 3, 2025

(54) SYSTEM FOR MAPPING AND EXECUTING USAGE OF MULTIPLE SOURCE ELEMENTS FOR COMPLETION OF A RESOURCE REQUEST

(71) Applicant: BANK OF AMERICA CORPORATION, Charlotte, NC (US)

(72) Inventors: Sandeep Kumar Chauhan, Miyapur (IN); Bhoomika Khatri, Delhi (IN); Bindhiya Sivanantham, Chennai (IN); Vinayak Rao Patwari, Suchitra (IN); Vengatesh Sundarapandian, Chennai (IN); Sugumar Dhivya, Chennai (IN); Suman Matury, Hyderabad (IN); Mangal Thangaraju, Frisco, TX (US)

(73) Assignee: BANK OF AMERICA CORPORATION, Charlotte, NC (US)

(21) Appl. No.: 18/374,930

(22) Filed: Sep. 29, 2023

(51) Int. Cl. G06F 9/50

(52) U.S. Cl. CPC G06F 9/5055

(57) ABSTRACT

Systems, computer program products, and methods are described herein for a system for mapping and executing usage of multiple source elements for completion of a resource request. The present disclosure is configured to receive source element data related to at least two source elements, establish resource request parameters, determine an execution source element, and execute a resource transfer in response to the resource request using the execution source element.

### TECHNOLOGICAL FIELD

Example embodiments of the present disclosure relate to systems for mapping and executing usage of multiple source elements for completion of a resource request.

### BACKGROUND

Failure to timely execute a resource distribution in response to a resource request due to lack of satisfactory resources in a designated source element adversely impacts both parties to the resource distribution. Further, barriers related to mapping and organizing resource requests across multiple source elements may result in a fragmented view of a user's existing and upcoming resource distributions, thereby increasing the likelihood of a resource distribution failure.

As such, a need exists to (1) allow a user to execute a resource distribution in response to a resource request using multiple, alternative source elements and (2) view and interact with a plethora of source elements and resource requests in one cohesive user interface. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for mapping and executing usage of multiple source elements for completion of a resource request.

The solution described herein allows a user to execute a resource distribution in response to a resource request using multiple, alternative source accounts and view and interact with a plethora of source accounts and resource requests in one cohesive user interface.

The system is configured to determine if a user's first preferred source element contains adequate funds to complete a resource request and will execute a resource distribution only if it determines that the source element has access to adequate resources. If it determines that there is not access to adequate resource, the system will continue to analyze the source elements provided by the user until a source element having a source element value greater than the resource request completion value is identified.

The system further comprises a means for projecting resource request parameters and displaying the projections on a user interface. Using the user interface, a user may view the projections and manipulate user's preferences related to execution of the resource request (for example, the user may elect to execute completion of the resource request before the projected resource request execution date or select a different source element as the most preferred source element for completing the resource request).

In one aspect, a system for mapping and executing usage of multiple source elements for completion of a resource request is provided. The system comprises a processing device and a non-transitory storage device containing instructions. When executed by the processing device, the instructions cause the processing device to receive source element data related to at least two source elements, establish resource request parameters, determine an execution source element, and execute a resource transfer in response to the resource request using the execution source element.

According to the first aspect, the step of establishing resource request parameters comprises receiving a resource request, the resource request comprising resource request data elements, extracting a first resource request data element from the resource request, wherein the first resource request data element comprises a temporal data element, projecting a time for completion of a resource request based upon the first resource request data element and establishing the projected time for completion as a resource request parameter, extracting a second resource request data element from the resource request, the second resource request element comprising a resource request value, and project a resource request completion value based upon the second resource request data element and establishing the projected resource request completion value as a resource request parameter;

According to the first aspect, the step of determining an execution source element comprises determining a first user preference comprising a first source element, extracting, from the first source element data, a source element value; determining if the first source element value is greater than the resource request completion value and (a) if the first source element value is greater than the resource request completion value, identifying the first source element as the execution source element or (b) if the first source element value is not greater than the resource request completion value, determining a second user preference, wherein the second user preference comprises a second source element, repeating the step of determining whether the first source element should be utilized for executing the resource request using the second source element, and repeating the step of determining whether the first source element should be utilized for executing the resource request using additional source elements until an execution source element has been identified.

In a second aspect, a computer program product for mapping and executing usage of multiple source elements for completion of a resource request, the computer program product comprising a non-transitory computer-readable medium comprising code is provided. The code causes an apparatus to receive source element data related to at least two source elements, establish resource request parameters, determine an execution source element, and execute a resource transfer in response to the resource request using the execution source element.

According to the second aspect, the step of establishing resource request parameters comprises receiving a resource request, the resource request comprising resource request data elements, extracting a first resource request data element from the resource request, wherein the first resource request data element comprises a temporal data element, projecting a time for completion of a resource request based upon the first resource request data element and establishing the projected time for completion as a resource request parameter, extracting a second resource request data element from the resource request, the second resource request element comprising a resource request value, and project a resource request completion value based upon the second resource request data element and establishing the projected resource request completion value as a resource request parameter;

According to the second aspect, the step of determining an execution source element comprises determining a first user preference comprising a first source element, extracting, from the first source element data, a source element value; determining if the first source element value is greater than the resource request completion value and (a) if the first source element value is greater than the resource request completion value, identifying the first source element as the execution source element or (b) if the first source element value is not greater than the resource request completion value, determining a second user preference, wherein the second user preference comprises a second source element, repeating the step of determining whether the first source element should be utilized for executing the resource request using the second source element, and repeating the step of determining whether the first source element should be utilized for executing the resource request using additional source elements until an execution source element has been identified.

In a final aspect, a method for mapping and executing usage of multiple source elements for completion of a resource request is provided. The method comprises receiving source element data related to at least two source elements, establishing resource request parameters, determining an execution source element, and executing a resource transfer in response to the resource request using the execution source element.

According to the final aspect, the step of establishing resource request parameters comprises receiving a resource request, the resource request comprising resource request data elements, extracting a first resource request data element from the resource request, wherein the first resource request data element comprises a temporal data element, projecting a time for completion of a resource request based upon the first resource request data element and establishing the projected time for completion as a resource request parameter, extracting a second resource request data element from the resource request, the second resource request element comprising a resource request value, and project a resource request completion value based upon the second resource request data element and establishing the projected resource request completion value as a resource request parameter;

According to the final aspect, the step of determining an execution source element comprises determining a first user preference comprising a first source element, extracting, from the first source element data, a source element value; determining if the first source element value is greater than the resource request completion value and (a) if the first source element value is greater than the resource request completion value, identifying the first source element as the execution source element or (b) if the first source element value is not greater than the resource request completion value, determining a second user preference, wherein the second user preference comprises a second source element, repeating the step of determining whether the first source element should be utilized for executing the resource request using the second source element, and repeating the step of determining whether the first source element should be utilized for executing the resource request using additional source elements until an execution source element has been identified.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for mapping and executing usage of multiple source elements for completion of a resource request, in accordance with an embodiment of the disclosure;

FIG. 2A illustrates a process flow for mapping and executing usage of multiple source elements for completion of a resource request, in accordance with an embodiment of the disclosure.

FIG. 2B illustrates a detailed process flow for establishing resource request parameters, in accordance with an embodiment of the invention.

FIG. 2C illustrates a detailed process flow for determining an execution source element, in accordance with an embodiment of the invention.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, a “resource request” is a request for resources in connection with a resource transfer. The completion of a resource request results in a resource transfer.

As used herein, a “resource request recipient” is a person or entity to whom resources will be transferred if a resource transfer is executed in response to a resource request.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

As used herein, a “resource request completion value” is the quantity of resources that must be transferred to complete a resource request.

As used herein, a “resource request parameter” may comprise any information related to or received in connection with a resource request. A resource request parameter may comprise, without limitation, the resource request recipient, the location of the resource request recipient, the type of resources received in connection with the resource request, or the payment instrument used in connection with the resource request.

As used herein, a “source element” is an element that corresponds to a vehicle for holding or transferring resources. For example, each of the following is a “source element”: a checking account, a savings account, and any payment instrument.

Failure to timely execute a resource distribution in response to a resource request due to lack of resources in a designated source account adversely impacts both parties to a resource distribution. Further, barriers related to mapping and organizing resource requests across multiple source accounts may result in a fragmented view of a user's existing and upcoming resource distributions, thereby increasing the likelihood of a resource distribution failure due to inadequate access to resources in a specified resource element.

The solution described herein allows a user to (1) execute a resource distribution in response to a resource request using multiple source accounts and (2) view and interact with a plethora of source accounts and resource obligations in one cohesive user interface.

The system is configured to determine if a user's first preferred source element contains resources to complete a resource request and will execute completion of the resource request only if it determines that there are enough available resources in the source element for completion of the resource request. If it determines that completion of the resource request requires more resources than are available in the source element, the system will continue to analyze the source elements provided by the user until a source element having a source element value greater than the resource request completion value is identified.

The system may further comprise a means for projecting resource request parameters and displaying the projections on a user interface. Using the user interface, a user may view the projections and manipulate user's preferences related to execution of the resource request (for example, the user may elect to execute the resource request before the projected resource request execution date or select a different source element as the most preferred source element for use during execution of the resource request).

What is more, the present disclosure provides a technical solution to a technical problem. As described herein, the technical problem includes failed resource transfers due to lack of resources in a source element. The technical solution presented herein allows for use of a variety of different source elements to complete a resource transfer. In particular, the ability to complete resource requests using source elements according to a tiered system developed by a user is an improvement over existing solutions to the problem of failed resource transfers because it provides a more accurate solution to the issue of the time elapsed between the initiation of a resource transfer and the completion of a resource request, which gives rise to failed resource transfers. Therefore, systems and methods discussed herein reduce the number of resources required to remedy any errors made due to a less accurate solution and removes the manual input required to correct the failed resource transfer. Furthermore, the technical solution described herein uses a rigorous, computerized process to perform specific tasks and/or activities that were not previously performed. In specific implementations, the technical solution bypasses a series of steps previously implemented, thus further conserving computing resources.

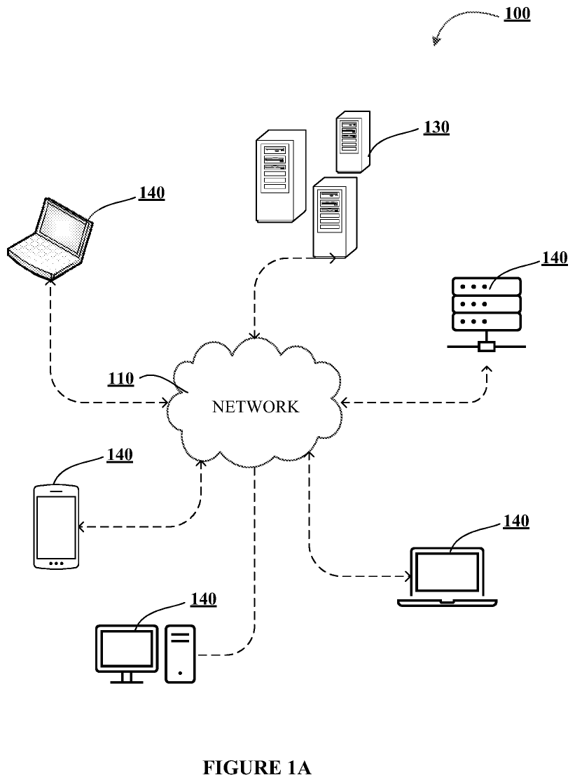

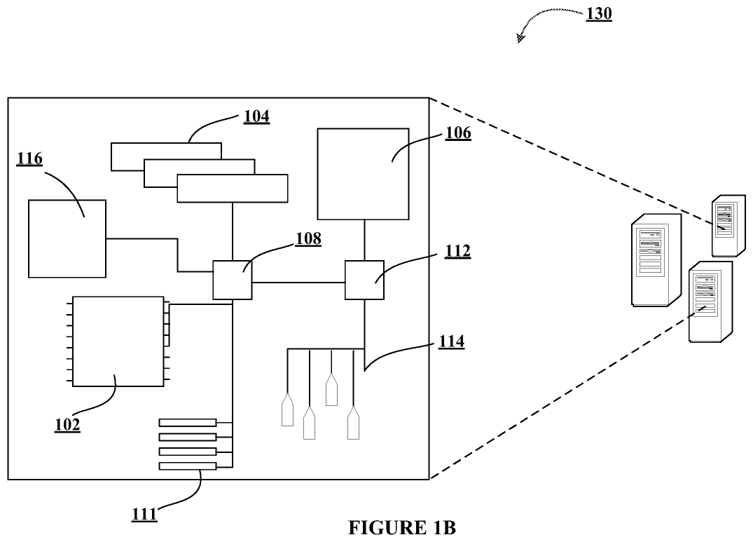

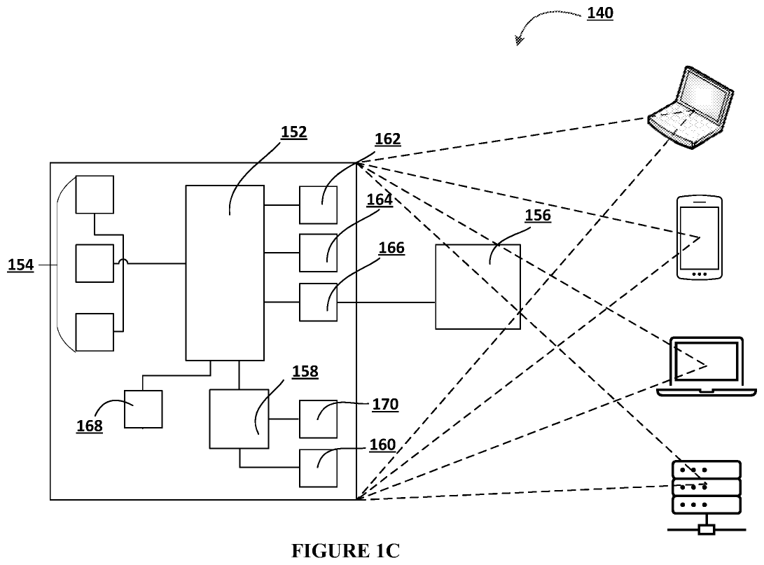

FIGS. 1A-1C illustrate technical components of an exemplary distributed computing environment for mapping and executing usage of multiple source elements for completion of a resource request 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

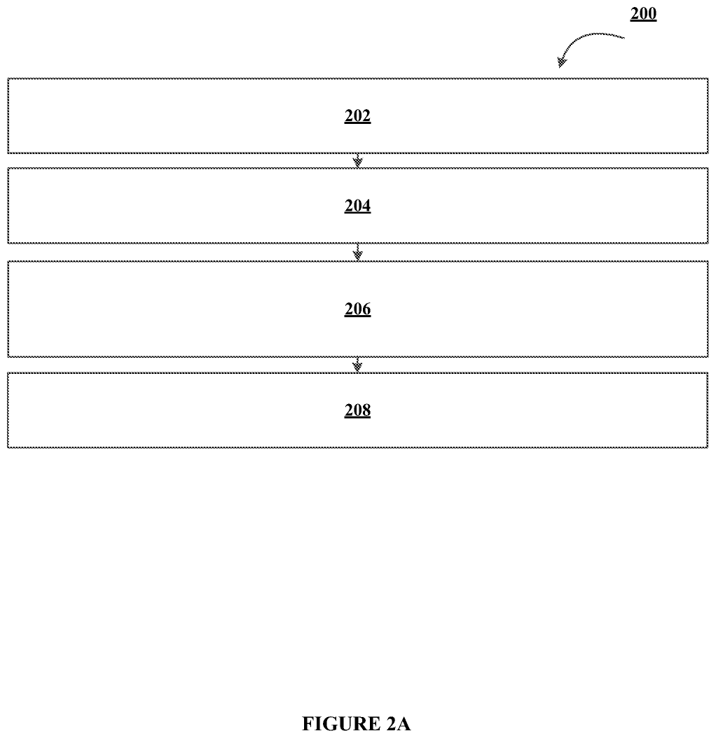

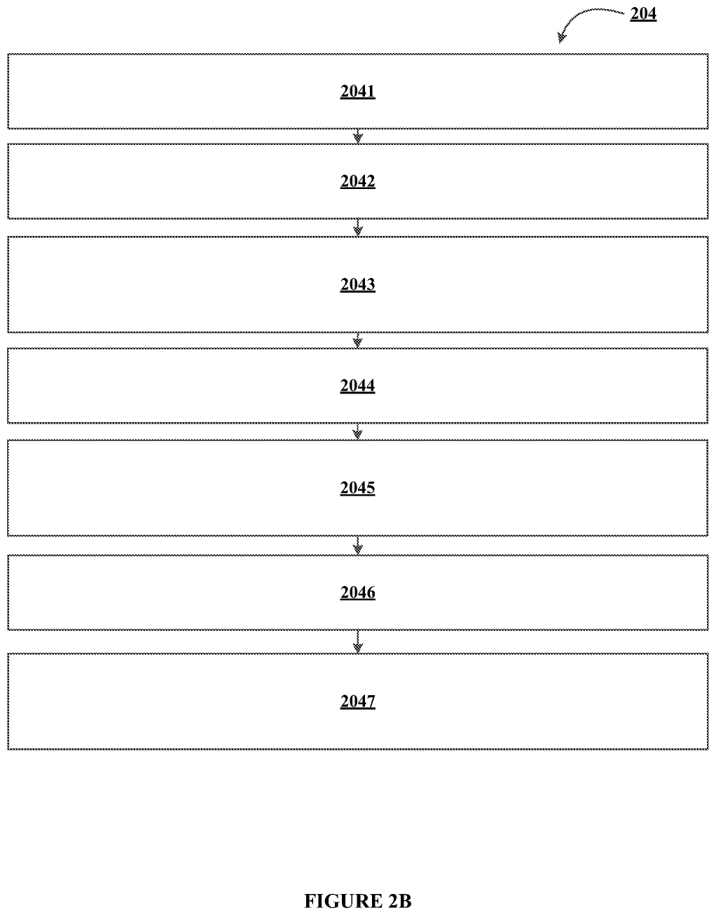

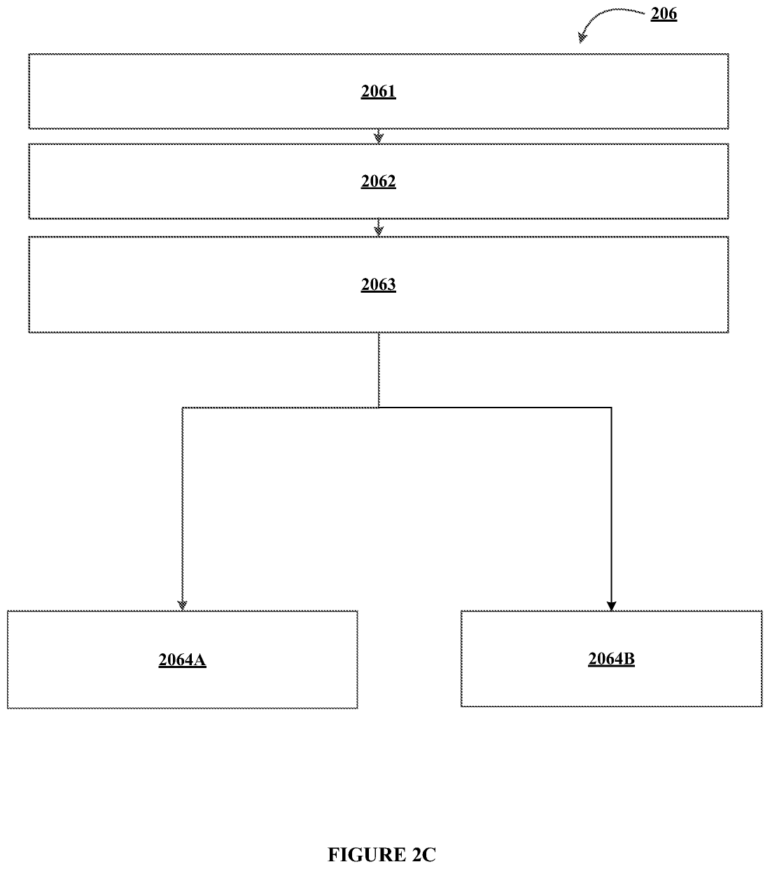

FIG. 2A illustrates a process flow for mapping and executing usage of multiple source elements for completion of a resource request 200, in accordance with an embodiment of the disclosure. The process of FIG. 2A comprises a first step 202 comprising receiving source element data, the source element data comprising data elements related to a source element; a second step 204 of establishing resource request parameters; a third step 206 of determining an execution source element; and a fourth step 208 of executing a resource transfer.

FIG. 2B provides a process flow for the step of establishing resource request parameters 204, which comprises a first step 2041 of receiving a resource request comprising resource request data elements; a second step 2042 of extracting a first resource request data element from the resource request comprising a temporal data element; a third step 2043 of projecting a time for completion of a resource request based upon the first resource request data element; a fourth step 2044 of establishing the projected time for completion as a resource request parameter; a fifth step 2045 of extracting a second resource request data element comprising a resource request value, a sixth step 2046 of projecting a resource request completion value based upon the second resource request data element; and a final step 2047 of establishing the projected resource request completion value as a resource request parameter.

FIG. 2C provides a process flow for the step of determining an execution source element 206, which comprises a first step 2061 of determining a first user preference comprising a first source element, a second step 2062 of extracting, a source element value from the first source element data; a third step 2063 of determining if the first source element value is greater than the resource request completion value and, if the first source element value is greater than the resource request completion value, a fourth step 2064A of identifying the first source element as the execution source element or, if the first source element value is not greater than the resource request completion value, a fourth step 2064B of determining a second user preference comprising a second source element, repeating the step of determining whether the first source element should be utilized for executing the resource request using the second source element, and repeating the step of determining whether the first source element should be utilized for executing the resource request using additional source elements until an execution source element has been identified.

In some embodiments, the process further comprises receiving, from a user input device, a user preference matrix comprising potential resource request parameters and source element selection data elements. Each of the source element selection data elements comprise a first user preference and a second user preference and each of the potential resource request parameters data element of the user preference matrix corresponds to a source selection data element of the user preference matrix. In this embodiment, at least the first user preference and the second user preference are determined by identifying a potential resource request parameter of the user preference matrix that matches one or more of the resource request parameters of the resource request, and extracting the first and second user preferences from the corresponding source element selection data element for use as the first and second user preferences for executing the resource request. In some such embodiments, the step of establishing resource request parameters further comprises extracting a third data element comprising a resource request recipient from the resource request and establishing the resource request recipient as a resource request parameter.

In other embodiments, the step of establishing resource request parameters further comprises extracting a third data element comprising a resource request type from the resource request, and establishing the resource request type as a resource request parameter. In some embodiments, the processor may be further configured to extract one or more data elements comprising information related to the resources transferred and/or the resource recipient and determine a resource request type based upon the resources transferred and/or the resource recipient. In order to identify a resource request type, the processor may access a database which identifies certain resources and/or resource recipients as connected to particular resource request types or through information input by a user categorizing certain resources or resource recipients by type.

In some embodiments, the step of determining the first user preference comprises determining the first user preference based upon the resource request completion value.

In some embodiments, the method further comprises extracting, from the source element data, an identity of an authorized source element user of the execution source element and notifying the authorized source element user after execution of the resource transfer.

In some embodiments, executing the instructions further causes the processing device to, before executing the resource request, extract, from the source element data, an identity of an authorized source element user of the execution source element, notify the authorized source element user that the execution source element was selected for execution of the resource request, request approval from the authorized source element user to execute the resource transfer, and if the authorized source element user provides approval, proceed to execute the request, but if the authorized source element user does not provide approval, determine a replacement source element for use as the execution source element. If the authorized source element user does not provide approval, the system may be further configured to request, from the authorized source element user, information related to the potential that the request is connected with an unauthorized resource transfer or an unauthorized source element user.

In some embodiments, an execution source element may not be identified because no source element data indicating a source element value has been provided. In such embodiments, the system, method and computer program product may comprise one or more additional steps in the process flow. In one such embodiment, a notification may be sent to the user indicating that no execution source element has been identified. This step may take place in advance of the projected time for completion of the resource request. Alternatively or in addition, an alternative source element may be provided. The alternative source element may be provided by the user or by an authorized third-party. Upon provision of the alternative source element, it may be designated as an alternative source element for continuous use, one-time use or use subject to constraints based upon to the applicable resource request parameters. Alternatively or in addition, a user may indicate that they are unable to complete the resource request. Upon a user's indication that they are unable to complete the resource request, the process flow may either (a) reject the resource request or (b) complete the resource request using an alternative source element provided by a source element administrator.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for mapping and executing usage of multiple source elements for completion of a resource request, the system comprising:
a processing device;
a non-transitory storage device containing instructions when executed by the processing device, causes the processing device to perform the steps of:
receiving source element data, the source element data comprising data elements related to at least two source elements;
establishing resource request parameters, wherein the step of establishing resource request parameters comprises:
receiving a resource request, the resource request comprising resource request data elements;
extracting a first resource request data element from the resource request, wherein the first resource request data element comprises a temporal data element;
projecting a time for completion of a resource request based upon the first resource request data element and establishing the projected time for completion as a resource request parameter;
extracting a second resource request data element from the resource request, the second resource request element comprising a resource request value; and
projecting a resource request completion value based upon the second resource request data element and establishing the projected resource request completion value as a resource request parameter;
determining an execution source element, the step of determining an execution source element comprising:
selecting a first user preference, wherein the first user preference comprises a first source element;
extracting, from the first source element data, a source element value;
determining if the first source element value is greater than the resource request completion value; and
(a) if the first source element value is greater than the resource request completion value, identifying the first source element as the execution source element or (b) if the first source element value is not greater than the resource request completion value, determining a second user preference, wherein the second user preference comprises a second source element, repeating the step of determining an execution source element using the second source element, and repeating the step of determining an execution source element using additional source elements until an execution source element has been identified; and
executing a resource transfer in response to the resource request using the execution source element.

2. The system of claim 1, further comprising a user interface wherein executing the instructions further causes the processing device to display, on the user interface, at least one of: the projected time for completion of a resource request, the resource request completion value, or the execution source element.

3. The system of claim 1, further comprising:
a user input device;
wherein executing the instructions further causes the processing device to:
receive, from the user input device, a user preference matrix comprising potential resource request parameters and source element selection data elements, each of the source element selection data elements comprising a first user preference and a second user preference;
wherein each of the potential resource request parameters data element of the user preference matrix corresponds to a source selection data element of the user preference matrix; and
wherein at least the first user preference and the second user preference are determined by:
identifying a potential resource request parameter of the user preference matrix that matches one or more of the resource request parameters of the resource request;
extracting the first and second user preferences from the corresponding source element selection data element for use as the first and second user preferences for executing the resource request.

4. The system of claim 3, wherein the step of establishing resource request parameters further comprises:
extracting a third data element from the resource request, the third data element comprising a resource request recipient; and
establishing the resource request recipient as a resource request parameter.

5. The system of claim 3, wherein the step of establishing resource request parameters further comprises:
extracting a third data element from the resource request, the third data element comprising a resource request type; and
establishing the resource request type as a resource request parameter.

6. The system of claim 1, wherein the step of determining the first user preference comprises determining the first user preference based upon the resource request completion value.

7. The system of claim 1, wherein executing the instructions further causes the processing device to:
extract, from the source element data, an identity of an authorized source element user of the execution source element; and
notify the authorized source element user after execution of the resource request.

8. The system of claim 1, wherein executing the instructions further causes the processing device to:
before executing the resource request, extract, from the source element data, an identity of an authorized source element user of the execution source element;
notify the authorized source element user that the execution source element was selected for execution of the resource request;
request approval from the authorized source element user to execute the resource request; and
if the authorized source element user does not provide approval, determining a replacement source element for use as the execution source element.

9. A computer program product for mapping and executing usage of multiple source elements for completion of a resource request, the computer program product comprising a non-transitory computer-readable medium comprising code causing an apparatus to:
receive source element data, the source element data comprising data elements related to at least two or more source elements;
establish resource request parameters, wherein establishing resource request parameters comprises:
receiving a resource request, the resource request comprising resource request data elements;
extracting a first resource request data element from the resource request, wherein the first resource request data element comprises a temporal data element;
projecting a time for completion of a resource request based upon the first resource request data element and establishing the projected time for completion as a resource request parameter;
extracting a second resource request data element from the resource request, the second resource request element comprising a resource request value; and
project a resource request completion value based upon the second resource request data element and establishing the projected resource request completion value as a resource request parameter;
determine an execution source element, the step of determining an execution source element comprising:
determining a first user preference, wherein the first user preference comprises a first source element;
extracting, from the first source element data, a source element value;
determining if the first source element value is greater than the resource request completion value; and
(a) if the first source element value is greater than the resource request completion value, identifying the first source element as the execution source element or (b) if the first source element value is not greater than the resource request completion value, determining a second user preference, wherein the second user preference comprises a second source element, repeating the step of determining an execution source element using the second source element, and repeating the step of determining an execution source element using additional source elements until an execution source element has been identified; and
execute a resource transfer in response to the resource request using the execution source element.

10. The computer program product of claim 9, wherein the code further causes the apparatus to:
display, on a user interface, at least one of: the projected time for completion of a resource request, the resource request completion value, or the execution source element.

11. The computer program product of claim 9, wherein the code further causes the apparatus to:
receive, from the user input device, a user preference matrix comprising potential resource request parameters and source element selection data elements, each of the source element selection data elements comprising a first user preference and a second user preference;
wherein each of the potential resource request parameters data element of the user preference matrix corresponds to a source selection data element of the user preference matrix; and
wherein at least the first user preference and the second user preference are determined by:
identifying a potential resource request parameter of the user preference matrix that matches one or more of the resource request parameters of the resource request;
extracting the first and second user preferences from the corresponding source element selection data element for use as the first and second user preferences for executing the resource request.

12. The computer program product of claim 11, wherein the code further causes the apparatus to:
extract a third data element from the resource request, the third data element comprising a resource request recipient; and
establish the resource request recipient as a resource request parameter.

13. The computer program product of claim 11, wherein the code further causes the apparatus to:
extract a third data element from the resource request, the third data element comprising a resource request type; and
establish the resource request type as a resource request parameter.

14. The computer program product of claim 9, wherein the first user preference is based upon the resource request completion value.

15. The computer program product of claim 9, wherein the code further causes the apparatus to:
extract, from the source element data, an identity of an authorized source element user of the execution source element; and
notify the authorized source element user after execution of the resource request.

16. The computer program product of claim 9, wherein the code further causes the apparatus to:
before executing the resource request, extract, from the source element data, an identity of an authorized source element user of the execution source element;
notify the authorized source element user that the execution source element was selected for execution of the resource request;
request approval from the authorized source element user to execute the resource request; and
if the authorized source element user does not provide approval, determine a replacement source element for use as the execution source element.

17. A method for mapping and executing usage of multiple source elements for completion of a resource request, the method comprising:
receiving source element data, the source element data comprising data elements related to at least two or more source elements;
establishing resource request parameters, wherein the step of establishing resource request parameters comprises:
receiving a resource request, the resource request comprising resource request data elements;
extracting a first resource request data element from the resource request, wherein the first resource request data element comprises a temporal data element;
projecting a time for completion of a resource request based upon the first resource request data element and establishing the projected time for completion as a resource request parameter;
extracting a second resource request data element from the resource request, the second resource request element comprising a resource request value; and
projecting a resource request completion value based upon the second resource request data element and establishing the projected resource request completion value as a resource request parameter;
determining an execution source element, the step of determining an execution source element comprising:
selecting a first user preference, wherein the first user preference comprises a first source element;
extracting, from the first source element data, a source element value;
determining if the first source element value is greater than the resource request completion value; and
(a) if the first source element value is greater than the resource request completion value, identifying the first source element as the execution source element or (b) if the first source element value is not greater than the resource request completion value, determining a second user preference, wherein the second user preference comprises a second source element, repeating the step of determining an execution source element using the second source element, and repeating the step of determining an execution source element using additional source elements until an execution source element has been identified; and
executing a resource transfer in response to the resource request using the execution source element.

18. The method of claim 17, wherein the method further comprises:
displaying, on a user interface, at least one of: the projected time for completion of a resource request, the resource request completion value, or the execution source element.

19. The method of claim 17, wherein the method further comprises:
receiving, from the user input device, a user preference matrix comprising potential resource request parameters and source element selection data elements, each of the source element selection data elements comprising a first user preference and a second user preference;
wherein each of the potential resource request parameters data element of the user preference matrix corresponds to a source selection data element of the user preference matrix; and
wherein at least the first user preference and the second user preference are determined by:
identifying a potential resource request parameter of the user preference matrix that matches one or more of the resource request parameters of the resource request;
extracting the first and second user preferences from the corresponding source element selection data element for use as the first and second user preferences for executing the resource transfer.

20. The method of claim 17, wherein the method further comprises:
extracting, from the source element data, an identity of an authorized source element user of the execution source element; and
notifying the authorized source element user after execution of the resource transfer.
